(19) United States
(12) Patent Application Publication
(10) Pub. No.: US 2024/0418352 A1
(43) Pub. Date: Dec. 19, 2024

(54) ELECTRICAL DEVICE

(71) Applicant: MAKITA CORPORATION, Anjo-shi (JP)

(72) Inventor: Masaaki Mitsuhashi, Anjo-shi (JP)

(73) Assignee: MAKITA CORPORATION, Anjo-shi (JP)

(21) Appl. No.: 18/654,103

(22) Filed: May 3, 2024

(30) Foreign Application Priority Data
Jun. 16, 2023 (JP) 2023-099131

(51) Int. Cl. F21V 21/08; F21L 4/00; F21V 21/40

(52) U.S. Cl. CPC F21V 21/08; F21L 4/00; F21V 21/406

(57) ABSTRACT

An electrical device includes: a main body including a light assembly that emits light; and a hook including a base part detachably attachable to the main body and a hanging part to be hung on an object, so as to suspend the main body from the object.

### CROSS-REFERENCE TO RELATED APPLICATION(S)

The present application claims priority to and incorporates by reference the entire contents of Japanese Patent Application No. 2023-099131 filed in Japan on Jun. 16, 2023.

### BACKGROUND OF THE INVENTION

### 1. Field of the Invention

The techniques disclosed in the present specification relate to an electrical device.

### 2. Description of the Related Art

In the technical field relating to an electrical device, a light including a hook that suspends a main body as disclosed in US 2021/0372604 A1 is known.

The light described in US 2021/0372604 A1 has a configuration in which the hook is fixed to the bottom surface of the main body. Therefore, the number of components of the entire light increases.

One non-limiting object of the present teachings is to provide an electrical device in which the number of components is reduced.

### SUMMARY OF THE INVENTION

The present specification discloses an electrical device. The electrical device may include: a main body including a light assembly that emits light; and a hook including a base part detachably attachable to the main body and a hanging part to be hung on an object, so as to suspend the main body from the object.

The techniques disclosed in the present specification provide an electrical device in which the number of components is reduced.

### BRIEF DESCRIPTION OF THE DRAWINGS

FIG. 1 is a perspective view from the upper left front illustrating an example of an electrical device according to an embodiment;

FIG. 2 is a perspective view the lower left front illustrating the example of the electrical device according to the embodiment;

FIG. 3 is a perspective view from the upper left rear illustrating the example of the electrical device according to the embodiment;

FIG. 4 is a schematic diagram illustrating an example of a hook;

FIG. 5 is a perspective view from the upper left rear illustrating the example of the electrical device according to the embodiment;

FIG. 6 illustrates an example of a state in which a main body is suspended;

FIG. 7 is a perspective view from the upper left rear illustrating another example of the electrical device according to the embodiment;

FIG. 8 is a diagram illustrating an example in the case in which an annular part of a main body hook is in an erected with respect to a rear surface;

FIG. 9 is a diagram illustrating an example in the case in which the annular part of the main body hook is erected on a rear surface;

FIG. 10 is a perspective view from the upper left rear illustrating another example of the hook according to the embodiment;

FIG. 11 is a perspective view from the upper left rear illustrating another example of the electrical device according to the embodiment;

FIG. 12 is a perspective view from the upper left rear illustrating an example of an electrical device according to the embodiment;

FIG. 13 is a perspective view from the upper left rear illustrating another example of the electrical device according to the embodiment;

FIG. 14 is a diagram illustrating an example of the case in which a hook is attached to and detached from a main body;

FIG. 15 is a perspective view from the upper left rear illustrating another example of the electrical device according to the embodiment;

FIG. 16 is a perspective view from the upper left rear illustrating another example of the electrical device according to the embodiment;

FIG. 17 is a diagram illustrating an example of housing parts;

FIG. 18 is a diagram illustrating the example of the housing parts;

FIG. 19 is a diagram illustrating another example of the state in which the main body is suspended;

FIG. 20 is a diagram illustrating another example of the state in which the main body is suspended;

FIG. 21 is a diagram illustrating another example of the state in which the hook is attached to the main body; and

FIG. 22 is a diagram illustrating another example of the state in which the hook is attached to the main body.

### DETAILED DESCRIPTION OF THE PREFERRED EMBODIMENTS

In one or more embodiments, an electrical device may include: a main body including a light assembly that emits light; and a hook including a base part detachably attachable to the main body and a hanging part to be hung on an object, so as to suspend the main body from the object.

According to the above-mentioned configuration, since the base part of the hook is provided to be detachably attachable in the main body, the main body can be suspended by attaching the base part to the main body and hanging the hanging part on the object. When the main body is not suspended, the main body can be used alone by detaching the base part from the main body. Therefore, since it is unnecessary to fix the hook to the main body, the number of components of the electrical device is reduced.

In the one or more embodiments, the main body may include an attachment part to which the base part of the hook is detachably attachable.

According to the above-mentioned configuration, by attaching and detaching the base part of the hook to and from the attachment part, the hook can be easily attached to and detached from the main body.

In the one or more embodiments, the attachment part may be disposed on an opposite side to the light assembly in the main body.

According to the above-mentioned configuration, since the attachment part is disposed on the opposite side to the light assembly in the main body, when the main body is suspended in a state in which the hook is attached to the attachment part, it is possible to prevent the light from the light assembly from being blocked by the attachment part and the hook.

In the one or more embodiments, the attachment part may be disposed at a position on an opposite side in a light emitting direction to a portion where the light assembly is disposed in the main body.

According to the above-mentioned configuration, since the attachment part is provided at the position on the opposite side to the light assembly in the light emitting direction in the main body, when the main body is suspended in a state in which the hook is attached to the attachment part, light can be emitted downward from the light assembly.

In the one or more embodiments, a plurality of the attachment parts may be provided in a plurality of portions of the main body.

According to the above-mentioned configuration, since the attachment parts are provided in the plurality of portions of the main body, the hook can be attached to and detached from a desired attachment part.

In the one or more embodiments, the attachment part may include a threaded hole, and the base part may include a threaded part configured to be screw-joined into the threaded hole.

According to the above-mentioned configuration, the hook can be attached to the attachment part by screw-joining the threaded part into the threaded hole of the attachment part, and the hook can be detached from the attachment part by releasing the screw-joining. Therefore, the hook can be easily attached to and detached from the attachment part.

In the one or more embodiments, the attachment part may include a closed-shaped main body hook supported by the main body, and the base part may include a main body hanging part to be hung on the main body hook.

According to the above-mentioned configuration, the hook can be attached to the attachment part by hanging a first main body hanging part on the main body hook of the attachment part, and the hook can be detached from the attachment part by releasing locking of the first main body hanging part. Therefore, the hook can be easily attached to and detached from the attachment part.

In the one or more embodiments, the main body hook may include a movement suppressing part that suppresses movement of the hook in a direction in which the main body hook extends.

According to the above-mentioned configuration, in a state in which the first main body hanging part of the hook is hung on the main body hook, the movement of the hook in the direction in which the main body hook extends is suppressed by the movement suppressing part. Therefore, it is possible to suppress positional deviation of the main body in a state in which the main body is suspended.

In the one or more embodiments, one of the attachment part and the base part may include a first magnet, and the other of the attachment part and the base part may include a second magnet or a magnetic body attractable to the first magnet.

According to the above-mentioned configuration, the hook can be attached to the attachment part by attracting the first magnet and the second magnet or the magnetic body, and the hook can be detached from the attachment part by releasing the attraction between the first magnet and the second magnet or the magnetic body. Therefore, the hook can be easily attached to and detached from the attachment part.

In the one or more embodiments, the hook may be formed in a hook shape including an open part and may include a snap part capable of opening and closing the open part.

According to the above-mentioned configuration, the hook is prevented from falling off from the object by closing the open part with the snap part in a state in which the hook is hung on the object.

In the one or more embodiments, the attachment part may include: an insertion and removal part configured such that the hook is insertable into and removable from the insertion and removal part; a positioning part configured to position the hook;, and a guiding part configured to guide the hook between the insertion and removal part and the positioning part.

According to the above-mentioned configuration, the hook can be attached to the attachment part by inserting the hook into the insertion and removal part, moving the hook along the guiding part, and positioning the hook with the positioning part. The hook can be detached from the attachment part by releasing the positioning of the hook, moving the hook along the guiding part, and removing the hook from the insertion and removal part. Therefore, the hook can be easily attached to and detached from the attachment part.

In the one or more embodiments, the attachment part may include a shaft part fixed to the main body, and the base may include a second main body hanging part to be hung on the shaft part.

According to the above-mentioned configuration, the hook can be attached to the attachment part by hanging the second main body hanging part on the shaft part of the attachment part, and the hook can be detached from the attachment part by releasing locking of the second main body hanging part. Therefore, the hook can be easily attached to and detached from the attachment part.

In the one or more embodiments, the attachment part may include a housing part that houses the hook such that the hook is movable between a suspending position where the hook is suspended from the object and a housing position where the hook is housed.

According to the above-mentioned configuration, the hook can be movably housed at the suspending position and the housing position by the housing part. Therefore, the hook can be housed in the housing position when not in use.

In the one or more embodiments, the hook may include a moving mechanism that moves the hook between the suspending position and the housing position.

According to the above-mentioned configuration, since the hook is moved by the moving mechanism between the suspending position and the housing position in a state in which the hook is housed in the housing part, the hook can be easily taken in and out.

In the one or more embodiments, a handle part may be provided to be detachably attachable to the main body, and the base part may be detachably attachable to the handle part.

According to the above-mentioned configuration, the hook can be attached to and detached from the handle part. Since the handle part also serves as the attachment part to which the hook is attached, the hook can be attached without providing the attachment part in advance.

In the one or more embodiments, the electrical device may further include a connecting member connecting the hook and the main body.

According to the above-mentioned configuration, the hook can be prevented from falling off from the main body by connecting the hook and the main body with the connecting member.

Embodiments according to the present disclosure will be described below with reference to the drawings. However, the present disclosure is not limited to the embodiments. The components in the embodiment described below can be combined as appropriate. There are also situations in which some of the components are not used.

In the embodiment, positional relations among parts are explained using the terms “front”, “rear”, “left”, “right”, “up”, and “down”. These terms indicate relative positions or directions, with the center of an electrical device 1 as the reference. In the embodiment, a reference axis AX is defined in the electrical device 1. A direction parallel to the reference axis AX is referred to as an axial direction as appropriate, a direction intersecting the reference axis AX is referred to as a radial direction as appropriate, and a direction around the reference axis AX is referred to as a rotational direction as appropriate.

In the embodiment, the reference axis AX extends in the front-rear direction. The axial direction is the front-rear direction. One side in the axial direction is a front side, and the other side in the axial direction is a rear side. The radial direction includes the up-down direction and the left-right direction. In the radial direction, a position close to or a direction approaching the reference axis AX is referred to as radially inner side as appropriate, and a position far from or a direction away from the reference axis AX is referred to as radially outer side as appropriate.

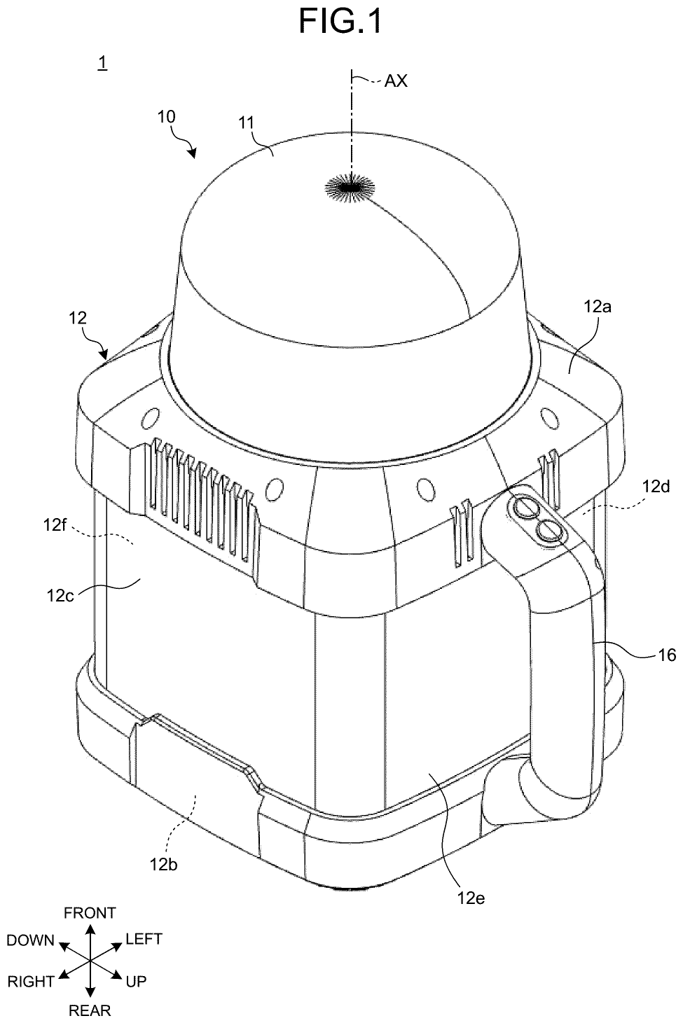

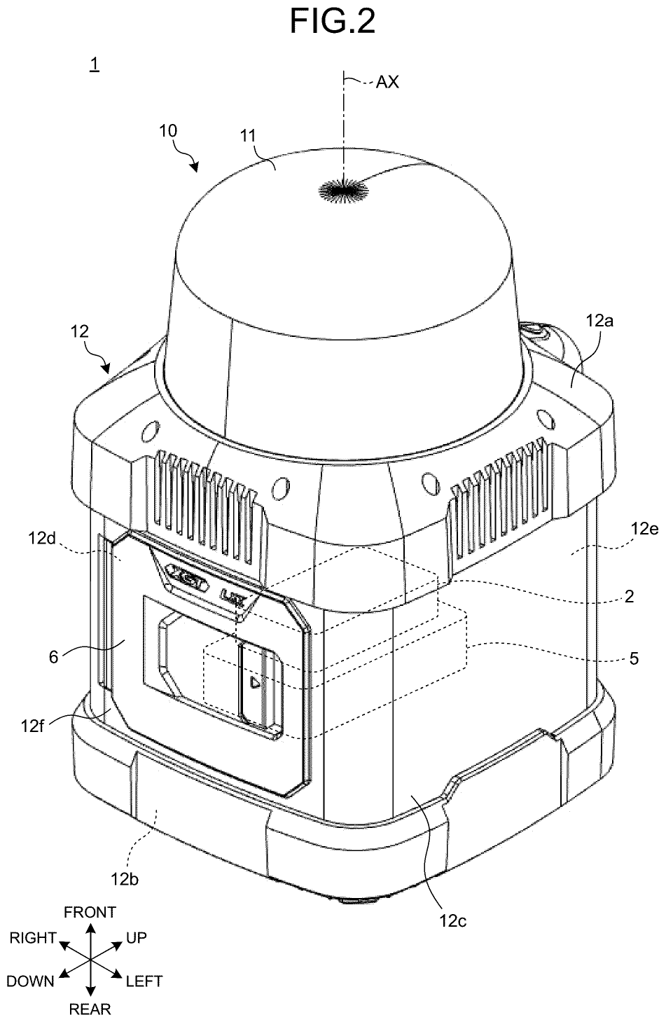

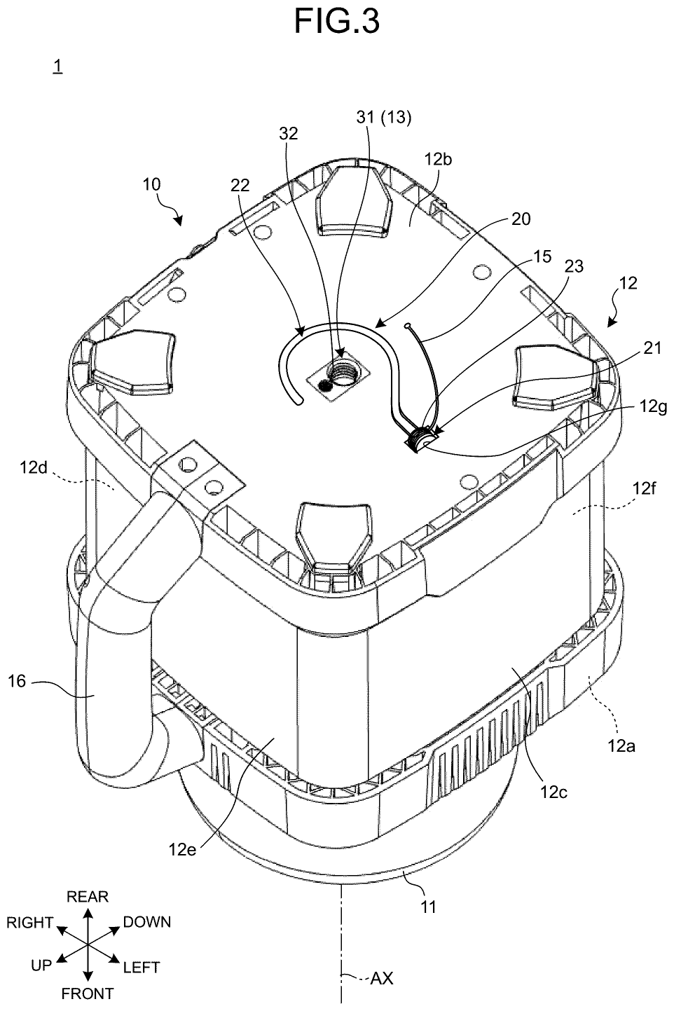

FIG. 1 is a perspective view from the upper left front illustrating an example of the electrical device 1 according to the present embodiment. FIG. 2 is a perspective view from the lower left front illustrating the example of the electrical device 1 according to the present embodiment. FIG. 3 is a perspective view from the upper left rear illustrating the example of the electrical device 1 according to the present embodiment.

In the present embodiment, the electrical device 1 is a portable electrical device that a user of the electrical device 1 can lift and transport by himself or herself. The electrical device 1 is a rechargeable electrical device that operates with electric power supplied from a rechargeable battery pack 2. The electrical device 1 is used as, for example, a lighting device at a work site. When work using a power tool is performed at the work site, the electrical device 1 is used to illuminate the power tool or a work target. The electrical device 1 includes a main body 10 and a hook 20.

The main body 10 includes a light assembly 11 and a housing 12. The light assembly 11 emits light. The light assembly 11 includes one or more light sources such as LEDs. The light assembly 11 is disposed to extend in the axial direction on the front side of the housing 12. The light assembly 11 emits light in, for example, each of the axial direction and the radial direction intersecting the axial direction.

The housing 12 holds the light assembly 11. The housing 12 is made of synthetic resin. The housing 12 has a rectangular parallelepiped shape extending in the axial direction parallel to the reference axis AX. The housing 12 has a front surface 12a, a rear surface 12b, a left surface 12c, a right surface 12d, an upper surface 12e, and a lower surface 12f. The housing 12 holds the light assembly 11 on the front surface 12a.

An attachment part 13 is provided on the rear surface 12b. The hook 20 is detachably attachable to the attachment part 13. An external structure such as a tripod is detachably attachable to the attachment part 13. The attachment part 13 is disposed at the center in the up-down direction and the left-right direction of the rear surface 12b. The attachment part 13 includes a threaded hole 31. The threaded hole 31 is a recess recessed forward from the rear surface 12b. The threaded hole 31 has a threaded part 32 formed in a side surface portion thereof. In the present embodiment, the attachment part 13 is disposed on the rear surface 12b on the opposite side to the front surface 12a on which the light assembly 11 is provided in the main body 10. In other words, the light assembly 11 is disposed in the front surface (first surface) 12a of the main body 10, the attachment part 13 is disposed on the rear surface (second surface) 12b of the main body 10, and the front surface 12a and the rear surface 12b face in opposite directions to each other. For this reason, when the main body 10 is suspended in a state in which the hook 20 is attached to the attachment part 13, it is possible to prevent light from the light assembly 11 from being blocked by the attachment part 13 and the hook 20.

A hook housing part 12g is provided on the rear surface 12b. The hook housing part 12g houses the hook 20. The hook housing part 12g is a recess having a shape conforming to the hook 20. The hook 20 can be housed in the hook housing part 12g. The hook 20 can be taken out from the hook housing part 12g. The hook housing part 12g is provided at a position surrounding the attachment part 13. The hook housing part 12g may be disposed at a position different from the position surrounding the attachment part 13.

A connecting member 15 is provided on the rear surface 12b. The connecting member 15 connects the hook 20 and the housing 12. The connecting member 15 connects the hook 20 and the housing 12 to thereby connect the hook 20 and the main body 10. The connecting member 15 is, for example, a linear member made of synthetic resin. The connecting member 15 may be formed using a material different from synthetic resin. The connecting member 15 is deformable following the movement of the hook 20.

A handle part 16 is attached to the upper surface 12e. The handle part 16 extends in the axial direction. The front end portion of the handle part 16 is connected to a front portion of an upper part of the housing 12. The rear end portion of the handle part 16 is connected to a rear portion of the upper part of the housing 12. The middle portion of the handle part 16 is separated from the housing 12.

An opening and closing part 6 is provided on the lower surface 12f. By opening the opening and closing part 6, the interior of the housing 12 can be accessed. A battery attachment part 5 is provided in the interior of the housing 12. The battery pack 2 is attached to the battery attachment part 5. The battery pack 2 is attachable to and detachable from the battery attachment part 5. The battery pack 2 includes a rechargeable battery. As the rechargeable battery, a rechargeable lithium-ion battery is exemplified. The battery pack 2 is a slide type battery pack. The battery pack 2 is a battery pack for a power tool. The battery attachment part 5 includes a not-illustrated guide part that guides the battery pack 2 in the up-down direction.

When attaching the battery pack 2 to the battery attachment part 5, a user of the electrical device 1 brings the upper end portion of the battery pack 2 into contact with the lower end portion of the battery attachment part 5 and thereafter slides the battery pack 2 upward with respect to the battery attachment part 5. The battery pack 2 moves upward while being guided by the guide part of the battery attachment part 5. The battery pack 2 is attached to the battery attachment part 5 by being slid upward with respect to the battery attachment part 5 from below the battery attachment part 5. A power supply terminal of the battery pack 2 and a power supply terminal of the battery attachment part 5 are connected, whereby electric power is supplied from the battery pack 2 to the electrical device 1.

When detaching the battery pack 2 from the battery attachment part 5, the user of the electrical device 1 operates a release button provided in the battery pack 2. The release button is operated, whereby the battery attachment part 5 and the battery pack 2 are unfixed. After the battery attachment part 5 and the battery pack 2 are unfixed, the battery pack 2 is slid downward, whereby the battery pack 2 is detached from the battery attachment part 5.

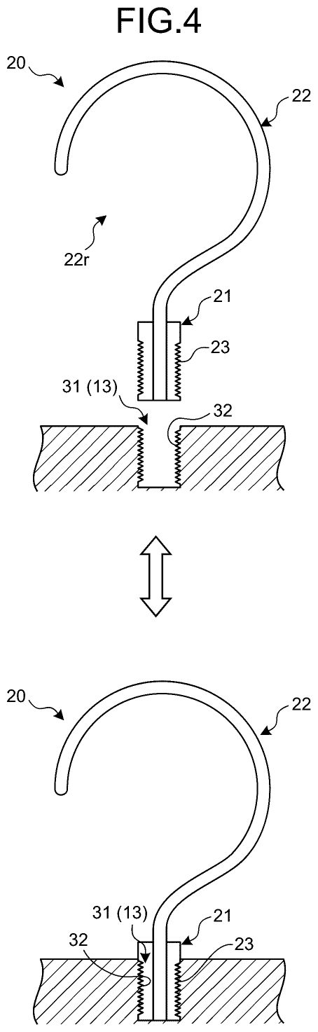

The hook 20 is housed in the hook housing part 12g. The hook 20 suspends the main body 10 from an object. FIG. 4 is a schematic diagram illustrating an example of the hook 20. The hook 20 includes a base part 21 and a hanging part 22.

The base part 21 is detachably attachable to the main body 10. The base part 21 includes a threaded part 23. The threaded part 23 is configured to be screw-joined to the threaded part 32 of the threaded hole 31 provided on the rear surface 12b of the housing 12. As illustrated in FIG. 4, the hook 20 is attached to the housing 12 (the main body 10) by screw-joining the threaded part 23 of the base part 21 into the threaded part 32 of the threaded hole 31.

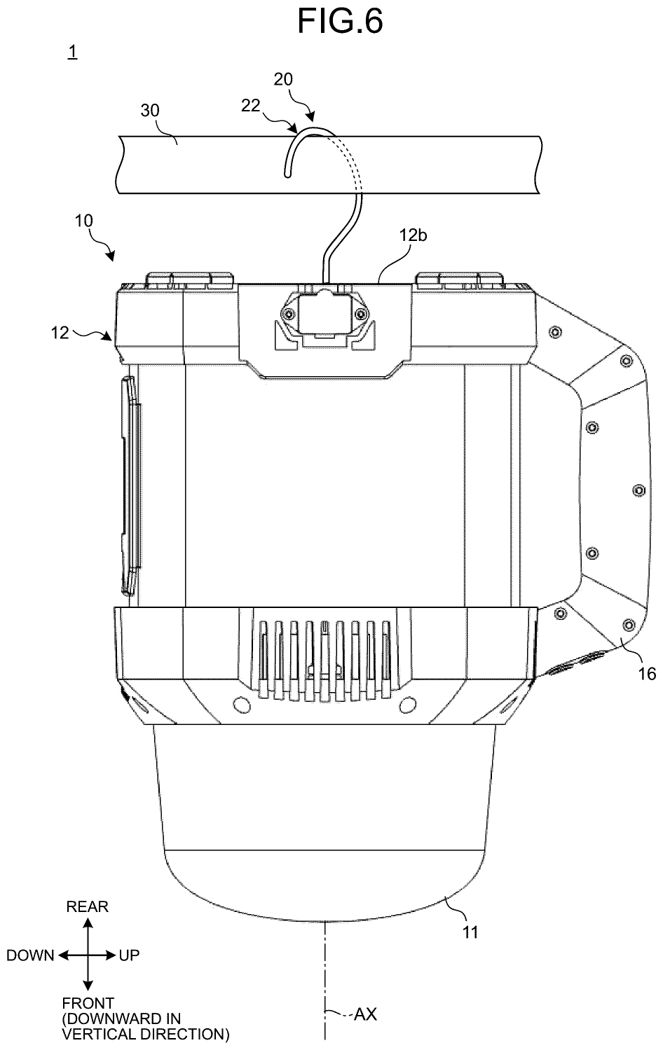

The hanging part 22 is hung on an object 30 (refer to FIG. 6). The hanging part 22 is formed in a hook shape including an open part 22r.

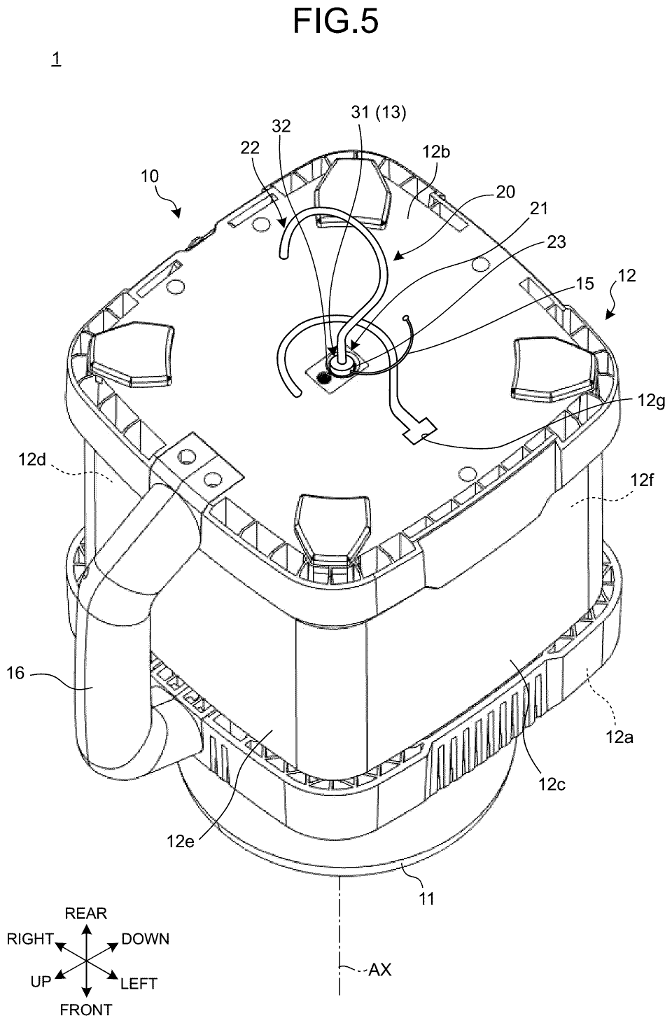

FIG. 5 is a perspective view from the upper left rear illustrating an example of the electrical device 1 according to the present embodiment. FIG. 5 illustrates an example of a state in which the hook 20 is attached to the main body 10. By screw-joining the base part 21 of the hook 20 to the threaded hole 31 of the housing 12, as illustrated in FIG. 5, the hook 20 is attached in a state in which the hook 20 protrudes rearward from the rear surface 12b of the housing 12.

FIG. 6 illustrates an example of a state in which the main body 10 is suspended. As illustrated in FIG. 6, the main body 10 may be suspended from the object 30 by hanging the hanging part 22 on the object 30 in a state in which the hook 20 is attached to the housing 12. In this state, the light assembly 11 disposed at a front part of the main body 10 faces downward in the vertical direction.

Since the base part 21 of the hook 20 and the threaded hole 31 of the housing 12 are joined by the screw-joining, the hook 20 is configured not to easily come off even if the weight of the main body 10 acts on the hook 20. For this reason, the main body 10 can be stably suspended from the object 30.

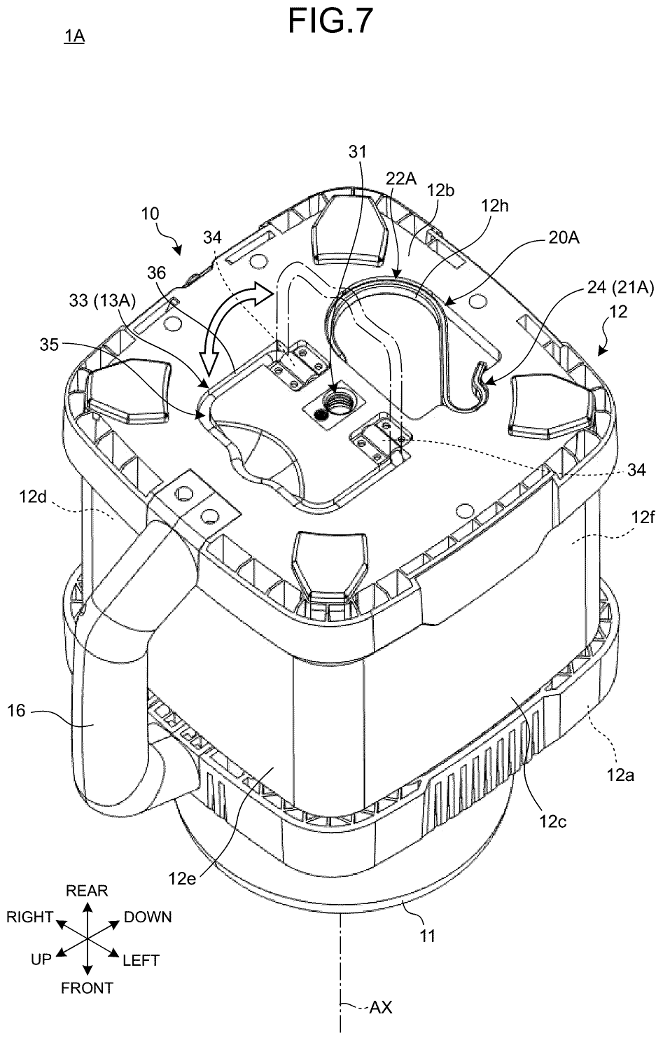

FIG. 7 is a perspective view from the upper left rear illustrating another example of the electrical device according to the present embodiment. In an electrical device 1A illustrated in FIG. 7, a main body hook 33 serving as an attachment part 13A is provided on a rear surface 12b. A hook 20A is detachably attachable to the main body hook 33. The main body hook 33 is formed by bending one bar-like member, for example. The main body hook 33 includes two base parts 34 and an annular part 35.

The base parts 34 respectively correspond to both end portions of the bar-like member in the longitudinal direction. The base parts 34 are respectively disposed on both sides of the threaded hole 31 in the left-right direction. The base parts 34 are disposed on the same straight line parallel to the left-right direction. The base parts 34 are disposed in a state in which the base parts 34 extend in the left-right direction. The base parts 34 are supported to be rotatable about a rotation axis BX parallel to the left-right direction.

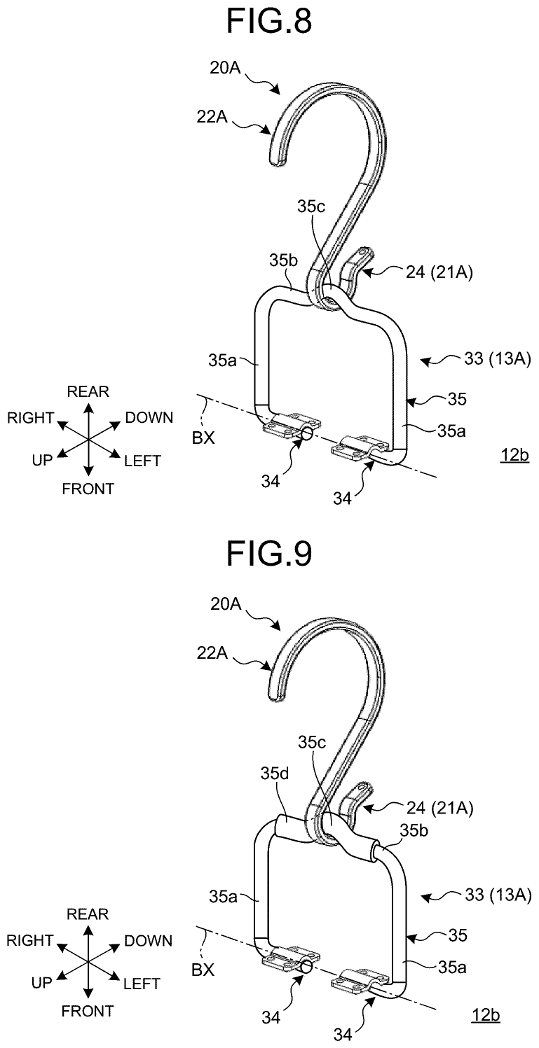

The annular part 35 connects the two base parts 34. The annular part 35 has a closed shape. The posture of the annular part 35 of the main body hook 33 can changed by turning about on the rotation axis BX. By changing the posture of the annular part 35, for example, the annular part 35 can be housed in a housing part 36 provided on the rear surface 12b. In this manner, the main body hook 33 can be housed in the housing 12 by housing the annular part 35 in the housing part 36. The housing part 36 is disposed on the upper side with respect to the threaded hole 31. The annular part 35 can be erected on the rear surface 12b. When erecting the annular part 35, the main body hook 33 may be configured to regulate the turning such that, for example, an angle between the annular part 35 and the rear surface 12b is maintained at a desired value. The annular part 35 includes two linear parts 35a and a coupling part 35b (refer to FIG. 8). The linear parts 35a extend in a direction orthogonal to the direction in which the base parts 34 extend. The coupling part 35b connects the two linear parts 35a to each other. The annular part 35 is formed in a closed shape by the two linear parts 35a and the coupling part 35b. The coupling part 35b includes a curved part 35c at the center in the left-right direction.

A hook housing part 12h is provided on the rear surface 12b. The hook housing part 12h houses the hook 20A. The hook housing part 12h is a recess having a shape conforming to the hook 20A. The hook 20A can be housed in the hook housing part 12h. The hook 20A can be taken out from the hook housing part 12h. The hook housing part 12h is disposed on the lower side with respect to the threaded hole 31.

The hook 20A includes a base part 21A and a hanging part 22A. The base part 21A has a main body hanging part (a first main body hanging part) 24. The main body hanging part 24 is hung on the curved part 35c of the main body hook 33. The hanging part 22A is hung on the object 30.

FIG. 8 is a diagram illustrating an example in the case in which the annular part 35 of the main body hook 33 is erected on the rear surface 12b. In the example illustrated in FIG. 8, the annular part 35 is in a state in which the annular part 35 is vertically erected on the rear surface 12b. From this state, the hook 20A is attached to the main body hook 33 by hanging the main body hanging part 24 of the hook 20A on the curved part 35c of the annular part 35. Since the main body hanging part 24 is hung on the curved part 35c, the hook 20A is prevented from moving in the left-right direction. By hanging the hanging part 22 of the hook 20A on the object 30 in a state in which hook 20A is attached to the main body hook 33, the main body 10 can be suspended from the object 30.

By hanging the main body hanging part 24 of the hook 20A on the main body hook 33, the hook 20A can be easily attached to the main body 10. Since the main body hanging part 24 of the hook 20A is hung on the curved part 35c of the main body hook 33, the hook 20A is configured not to easily fall off even when the weight of the main body 10 acts on the hook 20A. For this reason, the main body 10 can be stably suspended from the object 30.

FIG. 9 is a diagram illustrating an example in the case in which the annular part 35 of the main body hook 33 is erected on the rear surface 12b. In the example illustrated in FIG. 9, a movement suppressing member 35d is attached to the coupling part 35b of the annular part 35. The movement suppressing member 35d is formed in a cylindrical shape using a material such as rubber. The movement suppressing member 35d is provided in a portion including the curved part 35c. For this reason, a portion covering the curved part 35c in the movement suppressing member 35d is curved along the curved part 35c. As illustrated in FIG. 9, by hanging the main body hanging part 24 of the hook 20A on the curved portion of the movement suppressing member 35d, the movement of the main body hanging part 24 in the left-right direction is more securely suppressed by the movement suppressing member 35d.

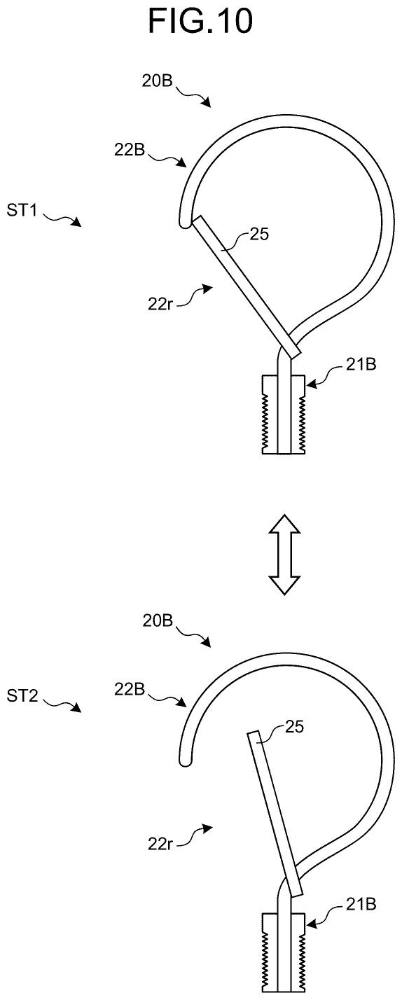

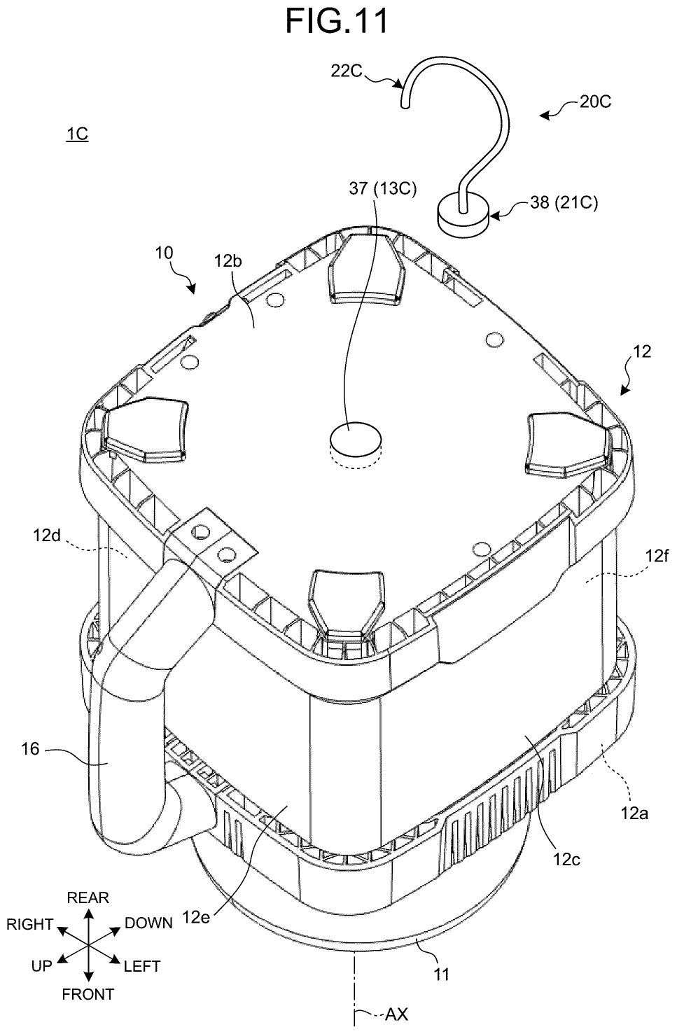

FIG. 10 is a perspective view from the upper left rear illustrating another example of the hook according to the present embodiment. A hook 20B illustrated in FIG. 10 includes a base part 21B and a hanging part 22B. The hanging part 22B is formed in a hook shape including an open part 22r. The hook 20B includes a snap part 25 capable of opening and closing the open part 22r. The snap part 25 can change a state of the open part 22r between a first state in which the open part 22r is closed as illustrated in ST1 of FIG. 10 and a second state in which the open part 22r is opened as illustrated in ST2 of FIG. 10. By closing the open part 22r with the snap part 25 in a state in which the hook 20B is hung on an object, the hook 20B can be prevented from falling off from the object 30.

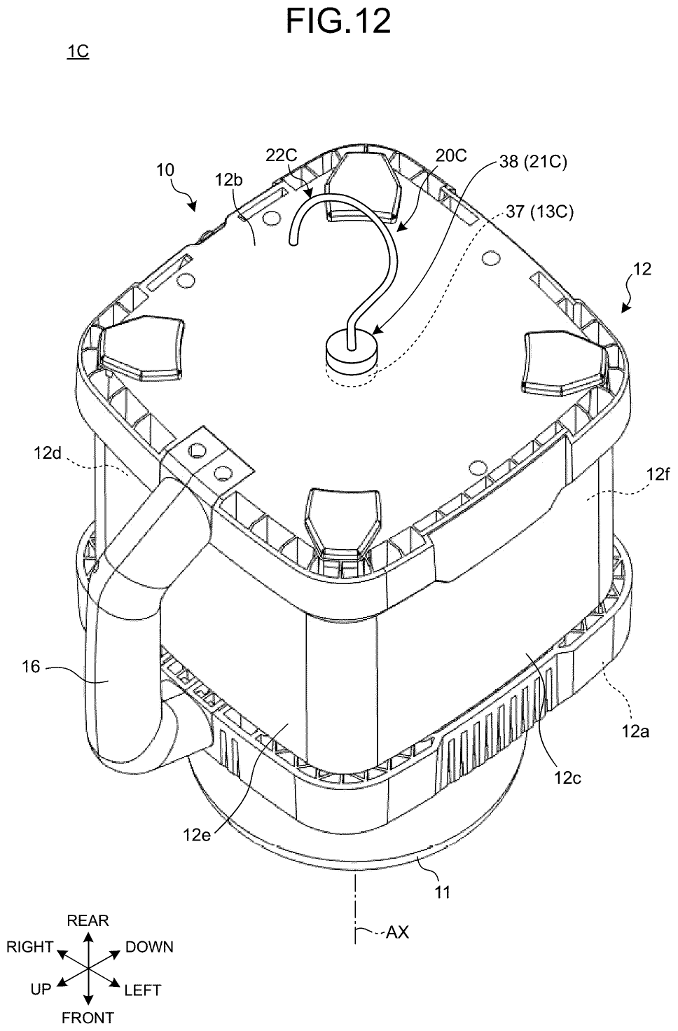

FIG. 11 is a perspective view from the upper left rear illustrating another example of the electrical device according to the present embodiment. In an electrical device 1C, one of the attachment part 13C of the rear surface 12b and a base part 21C of a hook 20C is provided with a first magnet 37, and the other is provided with a second magnet 38. In the electrical device 1C illustrated in FIG. 11, the attachment part 13C is provided with the first magnet 37, and the base part 21C of the hook 20C is provided with the second magnet 38. Instead of the second magnet 38, a magnetic body may be used.

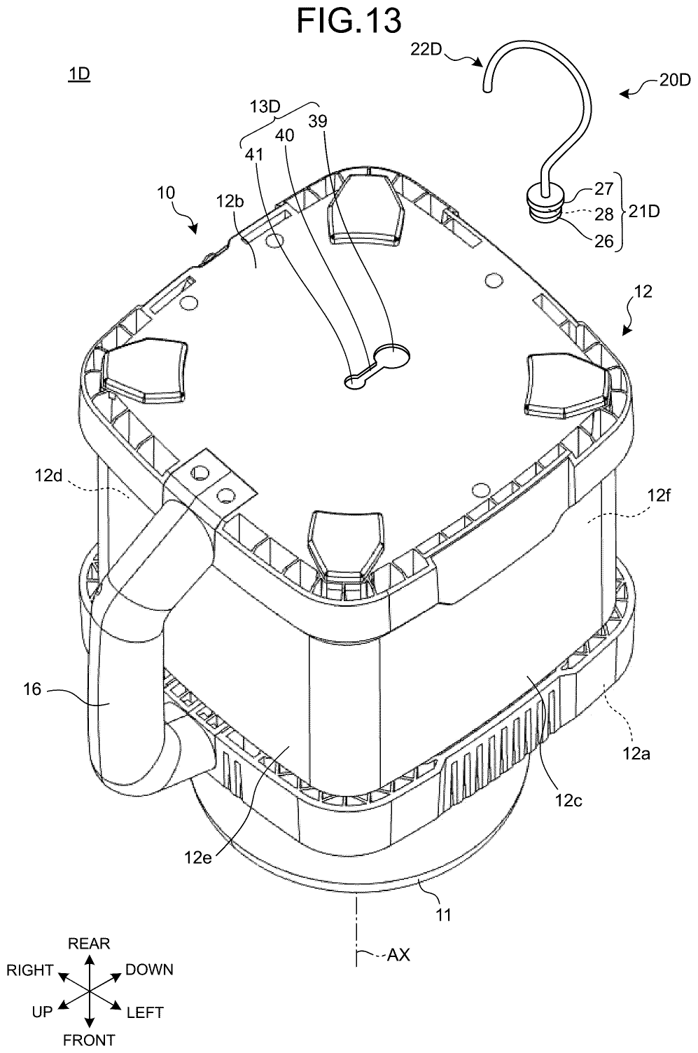

FIG. 12 is a perspective view from the upper left rear illustrating an example of the electrical device 1C according to the present embodiment. FIG. 12 illustrates an example of a state in which the hook 20C is attached to the main body 10. By attracting the second magnet 38 of the base part 21C of the hook 20C to the first magnet 37 of the attachment part 13C of the housing 12, as illustrated in FIG. 12, the hook 20C is attached to the main body 10 in a state in which the hook 20C protrudes rearward from the rear surface 12b of the housing 12. In this manner, since the hook 20C can be attached to the main body 10 by a magnetic force of the first magnet 37 and the second magnet 38, the hook 20C can be easily attached to the main body 10.

FIG. 13 is a perspective view from the upper left rear illustrating another example of the electrical device according to the present embodiment. In the electrical device 1D illustrated in FIG. 13, an insertion and removal part 39, a guiding part 40, and a positioning part 41, which serve as an attachment part 13D, are provided on the rear surface 12b. The insertion and removal part 39 is configured such that a hook 20D is capable of being inserted into and removed from the insertion and removal part 39. The positioning part 41 is configured to position the hook 20D. The guiding part 40 is configured to guide the hook 20D between the insertion and removal part 39 and the positioning part 41. The insertion and removal part 39 and the positioning part 41 each has a circular opening. The diameter of the insertion and removal part 39 is larger than the diameter of the positioning part 41. The guiding part 40 is a groove part extending along the up-down direction. The width (the dimension in the left-right direction) of the guiding part 40 is smaller than the diameter of the positioning part 41.

The hook 20D includes a base part 21D and a hanging part 22D. The base part 21D includes a first flange part 26 and a second flange part 27 each having a disk shape and a cylindrical shaft part 28. The diameter of the first flange part 26 is larger than the width of the guiding part 40 and the diameter of the positioning part 41 and is smaller than the diameter of the insertion and removal part 39 and the diameter of the second flange part 27. The diameter of the second flange part 27 is larger than the diameter of the insertion and removal part 39. The diameter of the shaft part 28 is smaller than the width of the guiding part 40.

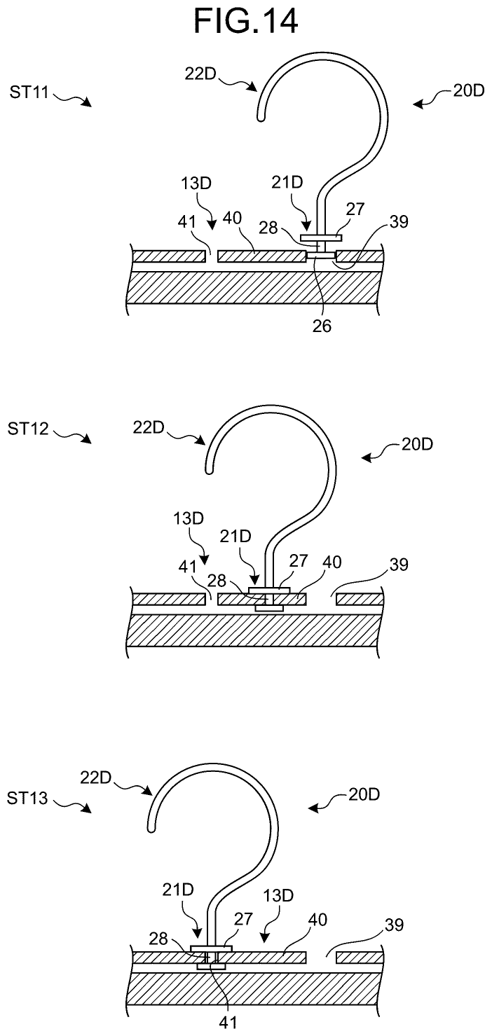

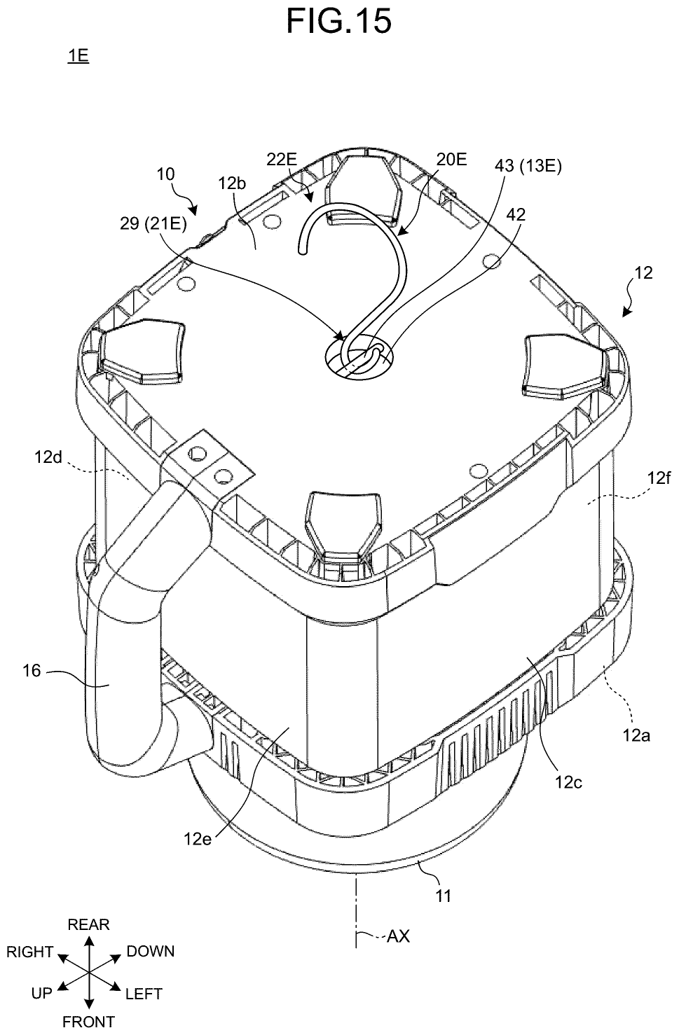

FIG. 14 is a diagram illustrating an example of the case in which the hook 20D is attached to and detached from the main body 10. When attaching the hook 20D to the housing 12, the first flange part 26 of the hook 20D is inserted into the insertion and removal part 39 as illustrated in ST11 of FIG. 14. At this time, since the diameter of the first flange part 26 is smaller than the diameter of the insertion and removal part 39, the first flange part 26 enters the insertion and removal part 39. Since the diameter of the second flange part 27 is larger than the diameter of the insertion and removal part 39, the second flange part 27 is not inserted into the insertion and removal part 39 and remains on the rear surface 12b. After the first flange part 26 is inserted into the insertion and removal part 39, the shaft part 28 is moved along the guiding part 40 as illustrated in ST12 in FIG. 14. According to the movement of the shaft part 28, the shaft part 28 reaches the positioning part 41 as illustrated in ST13 in FIG. 14. The shaft part 28 reaches the positioning part 41, whereby the hook 20D is positioned. Since the diameter of the positioning part 41 is smaller than the diameter of the first flange part 26 and the diameter of the second flange part 27, the movement of the hook 20D in the front-rear direction is restricted.

When detaching the hook 20D from the housing 12, the hook 20D is moved from the positioning part 41 along the guiding part 40 and removed from the insertion and removal part 39. In this manner, the hook 20D can be easily attached to and detached from the attachment part 13D.

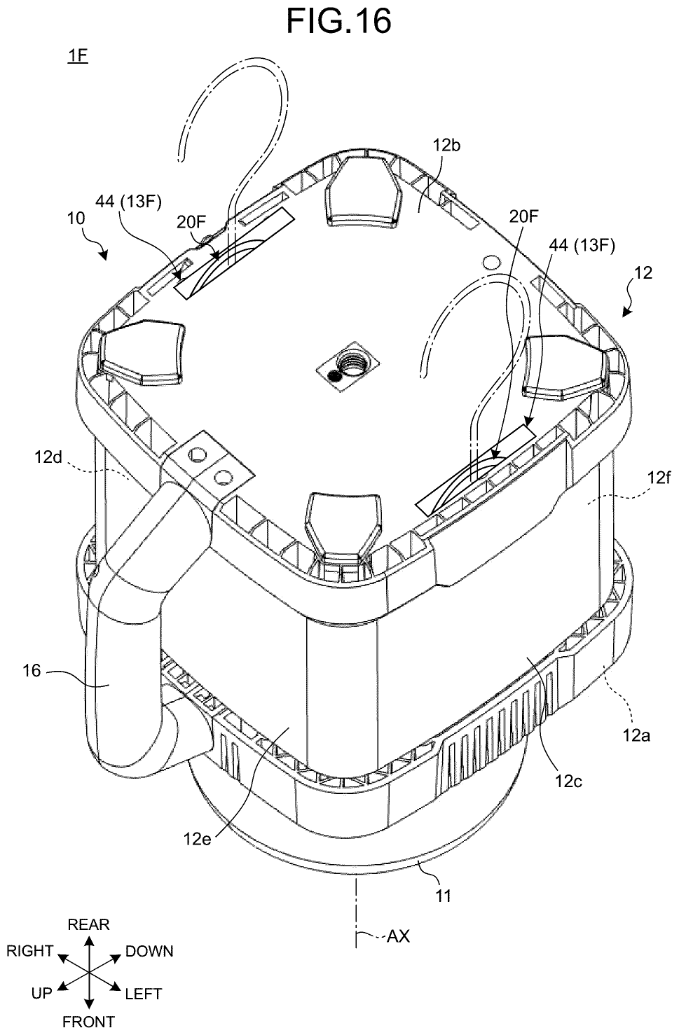

FIG. 15 is a perspective view from the upper left rear illustrating another example of the electrical device according to the present embodiment. In an electrical device 1E illustrated in FIG. 15, an opening 42 and a shaft part 43, which serve as an attachment part 13E, are provided on the rear surface 12b. The opening 42 has a circular shape and is provided at the center in the up-down direction and the left-right direction of the rear surface 12b. The shaft part 43 has a cylindrical shape and is fixed to the housing 12 to traverse the opening 42 in the up-down direction.

A hook 20E includes a base part 21E and a hanging part 22E. The base part 21E has a main body hanging part (a second main body hanging part) 29. The main body hanging part 29 is hung on the shaft part 43. The hanging part 22E is hung on an object.

As illustrated in FIG. 15, the hook 20E can be attached to the attachment part 13E by hanging the main body hanging part 29 on the shaft part 43 of the attachment part 13E. The hook 20E can be detached from the attachment part 13E by detaching the main body hanging part 29 from the shaft part 43. In this manner, the hook 20E can be easily attached to and detached from the attachment part 13E.

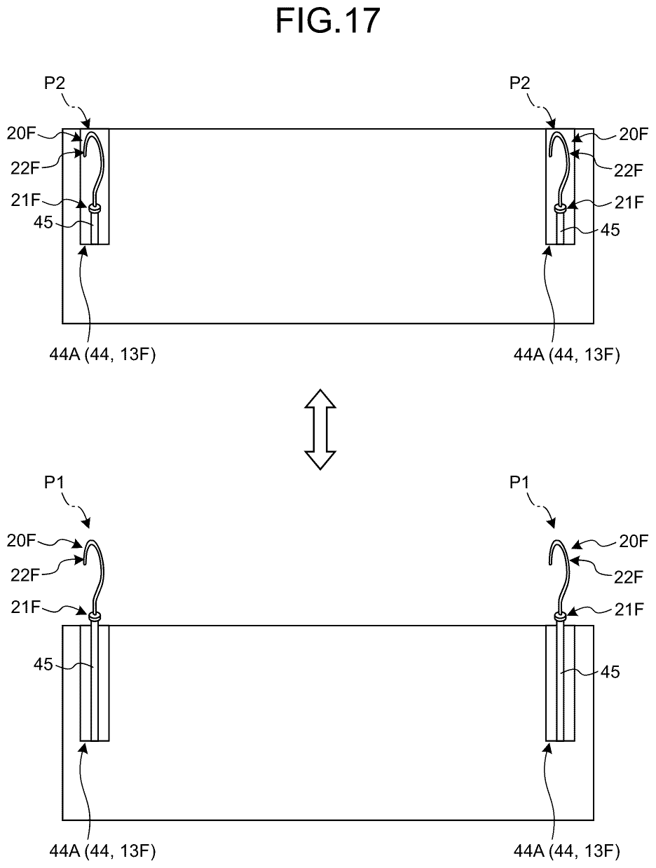

FIG. 16 is a perspective view from the upper left rear illustrating another example of the electrical device according to the present embodiment. In an electrical device 1F illustrated in FIG. 16, two housing parts 44, which serve as two attachment parts 13F, are provided on the rear surface 12b. For example, the housing parts 44 are disposed at both ends in the left-right direction on the rear surface 12b but are not limited to this configuration. The housing part 44 may be disposed in one place or three or more places. Each of the housing part 44 is configured to house a hook 20F such that the hook 20F is capable of moving between a suspending position P1 (see FIG. 17) where the hook 20F is suspended from an object and a housing position P2 (see FIG. 17) where the hook 20F is housed.

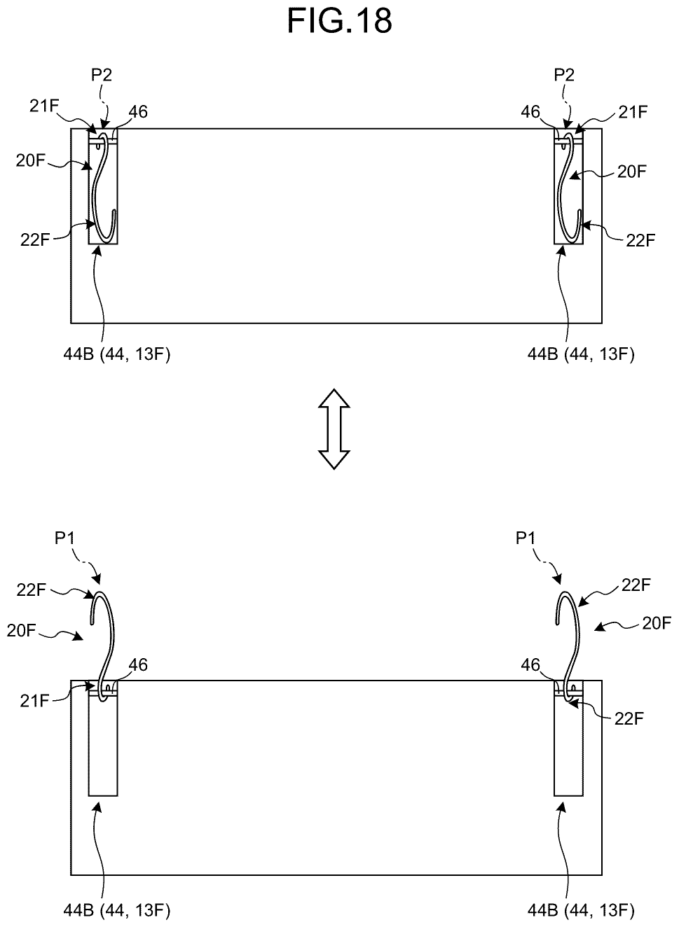

FIG. 17 and FIG. 18 are diagrams illustrating an example of the housing parts 44. As illustrated in FIG. 17, a moving mechanism 45 may be provided in each of the housing parts 44. The moving mechanism 45 moves the hook 20F between the suspending position P1 and the housing position P2. Alternatively, the moving mechanisms 45 may be provided on the hooks 20F. In this case, the moving mechanisms 45 are provided to be attachable to and detachable from the housing parts 44 together with the hooks 20F. In the housing parts 44 (44A) illustrated in FIG. 17, the moving mechanisms 45 are configured such that the hooks 20F are moved in parallel in the front-rear direction between the suspending position P1 and the housing position P2.

As illustrated in FIG. 18, in each of the housing parts 44 (44B), a shaft part 46 having the same configuration as the shaft part 43 illustrated in FIG. 15 may be provided. In this case, like the hook 20E illustrated in FIG. 15, the hook 20F may be configured such that the base part 21F is hung on the shaft part 46. In each of the housing parts 44B illustrated in FIG. 18, the moving mechanism 45 rotates the hook 20F about the shaft part 46 at a place between the suspending position P1 and the housing position P2 while keeping a state in which the base part 21F is hung on the shaft part 46. The shaft parts 46 may be provided to be attachable to and detachable from the housing parts 44B together with the hooks 20F.

The housing parts 44 (44A and 44B) illustrated in FIG. 17 and FIG. 18 are configured to house the hooks 20F such that the hooks 20F is capable of moving between the suspending position P1 and the housing position P2. Therefore, when the hooks 20F are not in use, the hooks 20F can be housed in the housing parts 44 at the housing position P2.

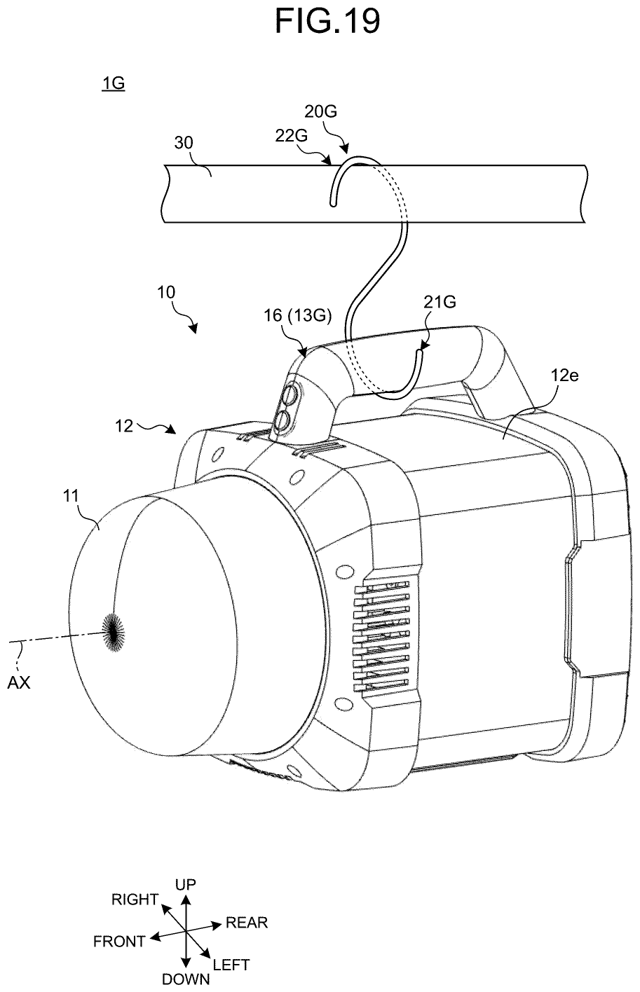

FIG. 19 is a diagram illustrating another example of the state in which the main body is suspended. In an electrical device 1G illustrated in FIG. 19, a hook 20G includes a base part 21G and a hanging part 22G. The hanging part 22G is hung on the object 30. The base part 21G is configured to be hung on the handle part 16 provided on the main body 10. By hanging the base part 21G on the handle part 16, the hook 20G can be attached to the main body 10. By detaching the base 21G from the handle part 16, the hook 20G can be detached from the main body 10.

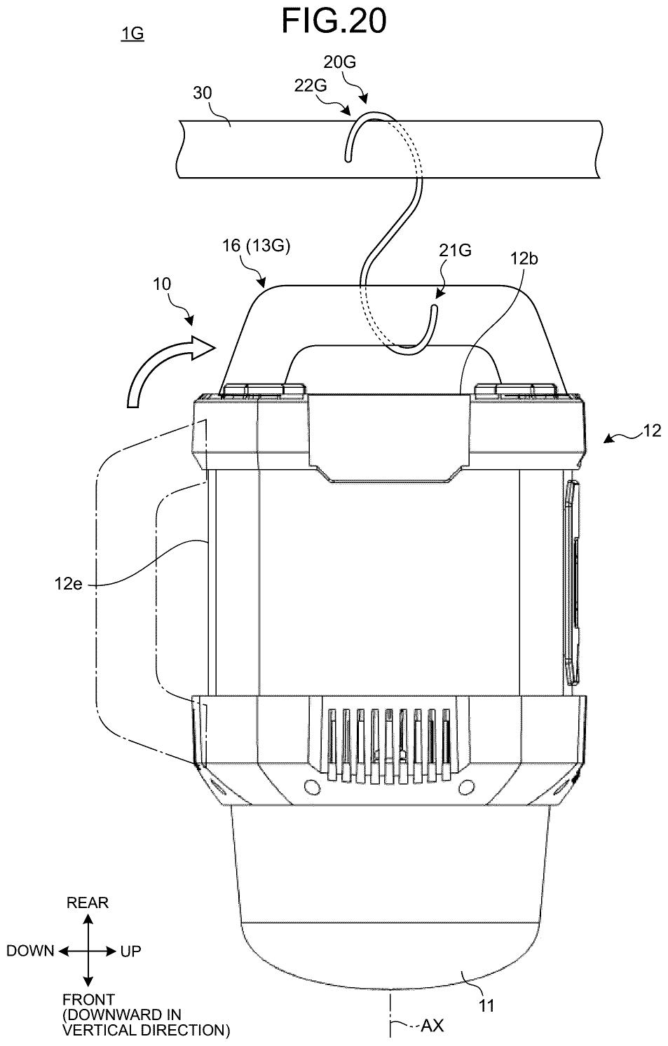

FIG. 20 is a diagram illustrating another example of the state in which the main body is suspended. In the electrical device 1G illustrated in FIG. 20, the handle part 16 may be configured to be relocatable to different positions of the housing 12. As an example of a configuration for relocating the handle part 16, the housing 12 may be configured to have: an insertion part into which the handle part 16 is inserted; a guiding part configured to guide the handle part 16; and a positioning part configured to position the handle part 16, similarly to the attachment part 13D illustrated in FIG. 13. FIG. 20 illustrates an example in which the handle part 16 is relocated from the upper surface 12e to the rear surface 12b. However, the handle part 16 is not limited to this configuration and may be relocated to another surface. By enabling the handle part 16 to be moved, the main body 10 can be suspended from the object 30 such that the light assembly 11 faces different directions.

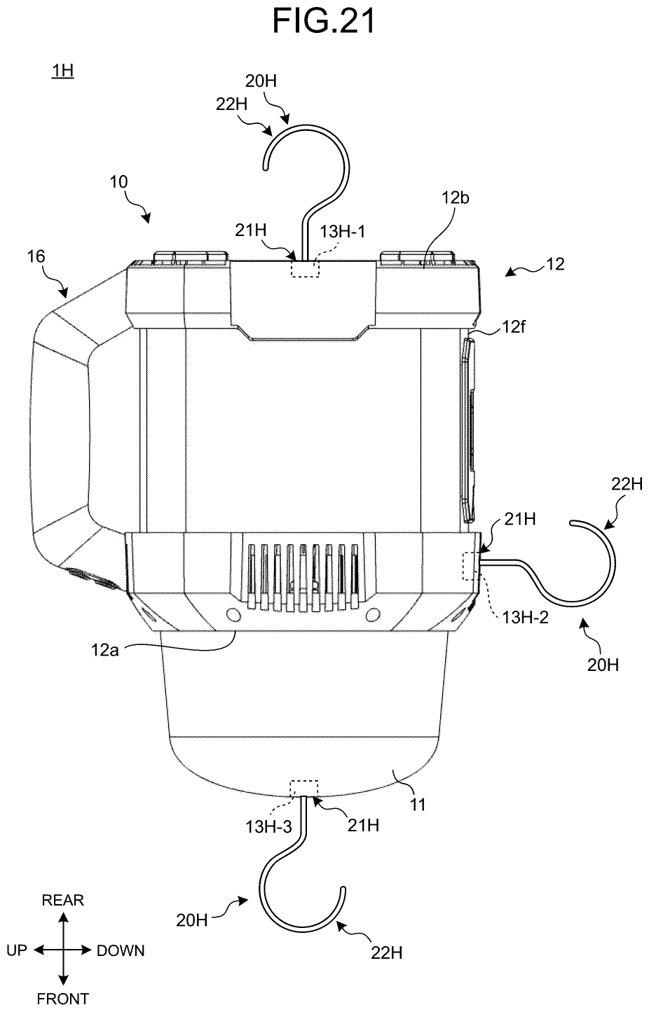

FIG. 21 is a diagram illustrating another example of the state in which the hook is attached to the main body. In an electrical device 1H illustrated in FIG. 21, in the main body 10, a plurality of attachment parts may be provided at a plurality of positions. In the example illustrated in FIG. 21, three attachment parts, i.e., a first attachment part 13H-1, a second attachment part 13H-2 and a third attachment part 13H-3, are provided. The first attachment parts 13H-1 is provided on the rear surface (second surface) 12b of the main body 10. The second attachment part 13H-2 is provided on the lower surface (third surface) 12f of the main body 10. The third attachment part 13H-3 is provided on the light assembly 11. The front surface (first surface) 12a of the main body on which the light assembly 11 is disposed and the rear surface (second surface) 12b of the main body 10 face in opposite directions to each other. The front surface (first surface) 12a of the main body 10 and the lower surface (third surface) 12f of the main body 10 are orthogonal to each other. In this manner, the attachment parts are not limited to be provided in (on) the housing 12 and may be provided in (on) the light assembly 11. In this case, a hook 20H can be attached to the light assembly 11. When suspending the main body 10 from an object in a state in which the hook 20H is attached to the light assembly 11, the light assembly 11 can emit light vertically upward.

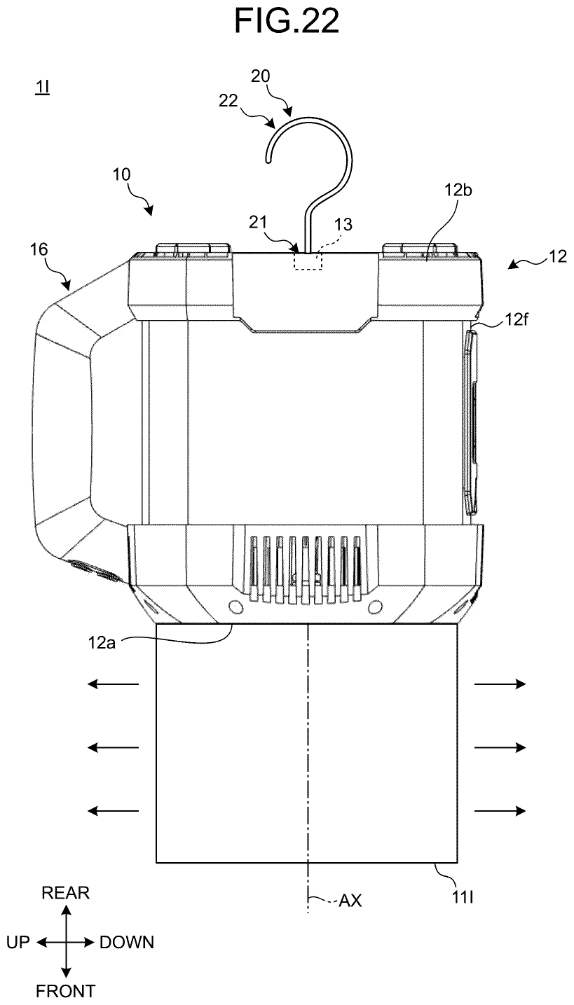

FIG. 22 is a diagram illustrating another example of the state in which the hook is attached to the main body 10. An electrical device 1I illustrated in FIG. 22 has a configuration in which a light assembly 11I emits light in a direction orthogonal to the reference axis AX. In other words, the light assembly 11I can emit light in a direction parallel to the rear surface (second surface) 12b of the main body 10. In FIG. 22, for example, the light assembly 11I has a configuration capable of emitting light in at least one of the upward direction and the downward direction. The attachment part 13 may be disposed, for example, at the central of the rear surface 12b. In this case, the attachment part 13 is disposed at a portion (i.e., the rear surface 12b or second surface) on the opposite side to a portion (i.e., the front surface 12a or first surface) where the light assembly 11I is disposed in the main body 10. With this configuration, since the attachment part 13 is provided at the portion on the opposite side to the light assembly 11 in the reference axis AX in the main body 10 and the light emitting direction of the light assembly 11I is parallel to the rear surface (second surface) 12b; when the main body 10 is suspended in a state in which the hook 20 is attached to the attachment part 13, light from the light assembly can be emitted without being blocked by the attachment part 13 and the hook 20.

As explained above, in the present embodiment, the electrical device 1 may include the main body 10 including the light assembly 11 that emits light and the hook 20 including the base part 21 detachably attachable to the main body 10 and the hanging part 22 to be hung on the object 30, so as to suspend the main body 10 from the object 30.

According to the above-mentioned configuration, since the base part 21 of the hook 20 is provided to be detachably attachable in the main body 10, the main body 10 is suspended by attaching the base part 21 to the main body 10 and hanging the hanging part 22 on the object 30. When the main body 10 is not suspended, the main body 10 can be used alone by detaching the base part 21 from the main body 10. Therefore, since the hook 20 does not need to be fixed to the main body 10, the number of components of the electrical device 1 is reduced.

In the present embodiment, the main body 10 may include the attachment part 13 to which the base part 21 of the hook 20 is detachably attached.

According to the above-mentioned configuration, by attaching and detaching the base part 21 of the hook 20 to and from the attachment part 13, it is possible to easily attach and detach the hook 20 to and from the main body 10.

In the present embodiment, the attachment part 13 may be disposed on the opposite side to the light assembly 11 in the main body 10.

According to the above-mentioned configuration, since attachment part 13 is disposed on the opposite side to the light assembly 11 in the main body 10, when the main body 10 is suspended in a state in which the hook 20 is attached to the attachment part 13, it is possible to prevent light from the light assembly 11 from being blocked by the attachment part 13 and the hook 20.

In the present embodiment, the attachment part 13 may be disposed at a position on the opposite side in the light emitting direction to the portion where the light assembly 11 is disposed in the main body 10.

According to the above-mentioned configuration, since the attachment part 13 is provided at the position on the opposite side to the light assembly 11 in the light emitting direction in the main body 10, when the main body 10 is suspended in a state in which the hook 20 is attached to the attachment part 13, light can be emitted from the light assembly 11 toward the opposite side to the suspending position.

In the present embodiment, the plurality of attachment parts 13 may be provided in a plurality of portions of the main body 10.

According to the above-mentioned configuration, since the attachment parts 13 are provided in the plurality of portions of the main body 10, the hook 20 can be attached to and detached from a desired attachment part 13.

In the present embodiment, the attachment part 13 may include the threaded hole 31, and the base part 21 may include the threaded part 23 configured to be screw-joined into the threaded hole 31.

According to the above-mentioned configuration, the hook 20 can be attached to the attachment part 13 by screw-joining the threaded part 23 into the threaded hole 31 of the attachment part 13, and the hook 20 can be detached from the attachment part 13 by releasing the screw-joining. Therefore, the hook 20 can be easily attached to and detached from the attachment part 13.

In the present embodiment, the attachment part 13A may include the main body hook 33 having the closed shape and supported by the main body 10, and the base part 21A may include the main body hanging part 24 to be hung on the main body hook 33.

According to the above-mentioned configuration, the hook 20A can be attached to the attachment part 13A by hanging the main body hanging part 24 on the main body hook 33 of the attachment part 13A, and the hook 20A can be detached from the attachment part 13A by releasing locking of the main body hanging part 24. Therefore, the hook 20 can be easily attached to and detached from the attachment part 13A.

In the present embodiment, the main body hook 33 may include the movement suppressing member 35d that suppresses movement of the hook 20A in the direction in which the main body hook 33 extends.

According to the above-mentioned configuration, in a state in which the main body hanging part 24 of the hook 20A is hung on the main body hook 33, the movement of the hook 20A in the direction in which the main body hook 33 extends is suppressed by the movement suppressing member 35d. Therefore, it is possible to suppress positional deviation of the main body 10 in a state in which the main body 10 is suspended.

In the present embodiment, one of the attachment part 13A and the base part 21B may include the first magnet 37, and the other of the attachment part 13B and the base part 21B may include the second magnet 38 or the magnetic body attractable to the first magnet 37.

According to the above-mentioned configuration, the hook 20B can attached to the attachment part 13B by attracting the first magnet 37 and the second magnet 38 or the magnetic body, and the hook 20B can be detached from the attachment part 13B by releasing the attraction of the first magnet 37 and the second magnet 38 or the magnetic body. Therefore, it is possible to easily attach and detach the hook 20B to and from the attachment part 13B.

In the present embodiment, the hook 20C may be formed in a hook shape including the open part 22r and may include a snap part capable of opening and closing the open part 22r.

According to the above-mentioned configuration, the hook 20C is prevented from falling off from the object 30 by closing the open part 22r with the snap part in a state in which the hook 20C is hung on the object 30.

In the present embodiment, the attachment part 13D may include: the insertion and removal part 39 configured such that the hook 20D is insertable into and removable from the insertion and removal part 39; the positioning part 41 configured to position the hook 20D; and the guiding part 40 configured to guide the hook 20D between the insertion and removal part 39 and the positioning part 41.

According to the above-mentioned configuration, the hook 20D can be attached to the attachment part 13D by inserting the hook 20D into the insertion and removal part 39, moving the hook 20D along the guiding part 40, and positioning the hook 20D with the positioning part 41. The hook 20D can be detached from the attachment part 13D by releasing the positioning of the hook 20D, moving the hook 20D along the guiding part 40, and removing the hook 20D from the insertion and removal part 39. Therefore, the hook 20D can be easily attached to and detached from the attachment part 13D.

In the present embodiment, the attachment part 13E may include the shaft part 43 fixed to the main body 10, and the base part 21 may include the main body hanging part 29 to be hung on the shaft part 43.

According to the above-mentioned configuration, the hook 20E can be attached to the attachment part 13E by hanging the main body hanging part 29 on the shaft part 43 of the attachment part 13E, and the hook 20E can be detached from the attachment part 13E by releasing locking of the main body hanging part 29. Therefore, the hook 20E can be easily attached to and detached from the attachment part 13E.

In the present embodiment, the attachment part 13F may include the housing part 44 that houses the hook 20F such that the hook 20F is movable between the suspending position P1 where the hook 20F is suspended from the object 30 and the housing position P2 where the hook 20F is housed.

According to the above-mentioned configuration, the hook 20F can be movably housed at the suspending position P1 and the housing position P2 by the housing part 44. Therefore, when the hook 20F is not in use, the hook 20F can be housed in the housing position P2.

In the present embodiment, the hook 20F may include the moving mechanism 45 that moves the hook 20F between the suspending position P1 and the housing position P2.

According to the above-mentioned configuration, since the hook 20F is moved by the moving mechanism 45 between the suspending position P1 and the housing position P2 in a state in which the hook 20F is housed in the housing part 44, the hook 20F can be easily taken in and out.

In the present embodiment, the handle part 16 may be provided to be detachably attachable to the main body 10, and the base part 21G may be detachably attachable to the handle part 16.

According to the above-mentioned configuration, the hook 20G can be attached to and detached from the handle part 16. Since the handle part 16 also serves as an attachment part to which the hook 20G is attached, the hook 20G can be attached without providing an attachment part in advance.

In the present embodiment, the electrical device 1 may further include the connecting member 15 that connects the hook 20 and the main body 10.

According to the above-mentioned configuration, the hook 20 can be prevented from falling off from the main body 10 by connecting the hook 20 and the main body 10 with the connecting member 15.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electrical device comprising:
a main body including a light assembly that emits light; and
a hook including a base part detachably attachable to the main body and a hanging part to be hung on an object, so as to suspend the main body from the object.

2. The electrical device according to claim 1, wherein the main body includes an attachment part configured such that the base part of the hook is detachably attachable to the attachment part.

3. The electrical device according to claim 2, wherein the attachment part is disposed on an opposite side to the light assembly in the main body.

4. The electrical device according to claim 2, wherein the attachment part is disposed at least at a position on an opposite side in a light emitting direction to a portion where the light assembly is disposed in the main body.

5. The electrical device according to claim 2, wherein a plurality of the attachment parts are provided in a plurality of portions of the main body.

6. The electrical device according to claim 2, wherein
the attachment part includes a threaded hole, and
the base part includes a threaded part configured to be screw-joined into the threaded hole.

7. The electrical device according to claim 2, wherein
the attachment part includes a main body hook having a closed shape and supported by the main body, and
the base part includes a first main body hanging part to be hung on the main body hook.

8. The electrical device according to claim 7, wherein the main body hook includes a movement suppressing part that suppresses movement of the hook in a direction in which the main body hook extends.

9. The electrical device according to claim 2, wherein
one of the attachment part and the base part includes a first magnet, and
another of the attachment part and the base part includes a second magnet or a magnetic body attractable to the first magnet.

10. The electrical device according to claim 2, wherein the hook is formed in a hook shape having an open part and includes a snap part configured to open and close the open part.

11. The electrical device according to claim 2, wherein the attachment part includes:
an insertion and removal part configured such that the hook is insertable into and removable from the insertion and removal part;
a positioning part configured to position the hook; and
a guiding part configured to guide the hook between the insertion and removal part and the positioning part.

12. The electrical device according to claim 2, wherein
the attachment part includes a shaft part fixed to the main body, and
the base part includes a second main body hanging part to be hung on the shaft part.

13. The electrical device according to claim 2, wherein the attachment part includes a housing part that houses the hook such that the hook is movable between a suspending position where the hook is suspended from the object and a housing position where the hook is housed.

14. The electrical device according to claim 13, wherein the hook includes a moving mechanism that moves the hook between the suspending position and the housing position.

15. The electrical device according to claim 1, further comprising
a handle part detachably attachable to the main body, wherein
the base part is detachably attachable to the handle part.

16. The electrical device according to claim 1, further comprising
a connecting member that connects the hook and the main body.

17. The electrical device according to claim 3, wherein
the light assembly is disposed on a first surface of the main body,
the attachment part is provided on a second surface of the main body, and
the first surface and the second surface face in opposite directions to each other.

18. The electrical device according to claim 2, wherein
the light assembly is disposed on a first surface of the main body,
the plurality of the attachment parts include:
a first assembly part provided on a second surface of the main body; and
a second assembly part provided on a third surface of the main body,
the first surface and the second surface face in opposite directions to each other, and
the first surface and the third surface are orthogonal to each other.

19. The electrical device according to claim 18, wherein
the plurality of the attachment parts further include a third attachment part, and
the third attachment part is provided on the light assembly.

20. The electrical device according to claim 2, wherein
the light assembly is disposed on a first surface of the main body,
the attachment part is disposed on a second surface of the main body,
the first surface and the second surface face in opposite directions to each other, and
a light emitting direction of the light assembly is parallel to the second surface.
